(19) United States
(12) Patent Application Publication
(10) Pub. No.: US 2002/0156639 A1
(43) Pub. Date: Oct. 24, 2002

(54) Business method for a digital photolithography system

(76) Inventors: Akira Ishikawa, Royse City, TX (US); Takashi Kanatake, Dallas, TX (US)

Correspondence Address: HAYNES AND BOONE, LLP, 901 MAIN STREET, SUITE 3100, DALLAS, TX, 75202, US

(21) Appl. No.: 09/794,778

(22) Filed: Feb. 27, 2001

(51) Int. Cl. G06F 17/60

(52) U.S. Cl. 705/1

(57) ABSTRACT

A method for determining a usage fee for a digital photolithography system is provided. The method is implemented as a computer program in a computer system used with the digital photolithography system. A digital mask is first received into the computer system, the digital mask being a source of pattern information for a digital pattern generator. Whenever a portion of the digital mask is transferred to the digital pattern generator, the transfer is detected and a counter is updated, accordingly. This is done only if the first digital mask is new. The usage fee can thereby be determined from the counter.

### BACKGROUND

The present invention relates generally to business methods for leasing/purchasing a maskless, digital photolithography system, such as can be used for printed circuit board or semiconductor fabrication.

Photolithography is a complicated and expensive processing operation for fabricating semiconductor wafers, printed circuit boards, and the like. For example, a photolithography system used for wafer fabrication may cost several hundred thousand dollars, or more, of initial investment. Furthermore, photolithography systems require constant maintenance and alignment to allow the systems to achieve very precise exposures.

In addition to the system costs, conventional photolithography systems must use one or more very expensive masks. Masks are transparent plates that provide a high-contrast pattern to be exposed onto a substrate (e.g., a wafer). For example, a mask may be a quartz plate with a patterned chromium film on it. It is typical for the photolithography system to use many different masks to expose a complex, multi-layer integrated circuit onto the wafer. Therefore, the different masks must be continually inserted in and removed from the photolithography system for the overall fabrication of the wafer.

Masks must also be replaced on a relatively frequent basis. Improvements in pattern design and normal damage from continued use require old masks to be discarded and new masks provided in their place. Therefore, masks can represent a continually recurring cost in wafer fabrication.

In U.S. Ser. No. 09/348,369, which is commonly assigned with the present invention and is hereby incorporated by reference, a maskless photolithography system is provided. For various reasons, however, many users of photolithography systems are reluctant to purchase such a maskless system. For example, the high initial cost of any photolithography system prevents users from such a purchase. Also, since the maskless technology is relatively new, many users will wait to see if the technology is indeed worthwhile.

Therefore, what is needed is a method for “selling” maskless photolithography systems that will be advantageous and desirable for both the seller and the user of such systems.

### SUMMARY

A technical advance is provided by a new and unique method for “selling” a digital photolithography system. In the preferred embodiment, the photolithography system includes a computer system and a digital pattern generator for performing digital photolithography on a substrate such as a wafer for multi-layered integrated circuits.

The method, all or part of which can be implemented as a computer program in the computer system, includes instructions for receiving a first digital mask into the computer system. The first digital mask is a source of pattern information for the digital pattern generator. Whenever a portion of the first digital mask is transferred to the digital pattern generator, the method detects the transfer and updates a counter, accordingly. This is done only if the first digital mask is new.

A usage fee can thereby be determined from the counter. In some embodiments, the usage fee is calculated as a function of a predetermined reference value, such as a typical cost for a conventional, physical mask. In some embodiments, the reference value changes for each new mask that is transferred to the digital pattern generator.

Therefore, the present invention provides a method for “selling” maskless photolithography systems that will be advantageous and desirable for both the seller and the user of such systems.

### BRIEF DESCRIPTION OF THE DRAWINGS

FIG. 1 illustrates a maskless photolithography system including a pattern generator and mask pattern design system for implementing embodiments of the present invention.

FIG. 2 presents the pattern generator and mask pattern design system of FIG. 1 in further detail.

FIG. 3 is a flow chart of a method that is used to perform the business method of the present disclosure.

### DETAILED DESCRIPTION

The present disclosure relates to business models and methods, such as can be used with maskless photolithography systems. It is understood, however, that the following disclosure provides many different embodiments, or examples, for implementing different features of the invention in specific applications. These embodiments are, of course, merely examples and are not intended to limit the invention from that described in the claims.

The present disclosure is divided into four different sections. The first section describes an exemplary maskless photolithography system. The second section describes a business method for “selling” the maskless photolithography system to an end user. The third section concludes by describing some of the many advantages of the methods previously discussed.

Exemplary System

Referring to FIG. 1, a maskless photolithography system 30, such as is disclosed in presently incorporated U.S. Ser. No. 09/348,369, can benefit from the present invention. The maskless photolithography system 30 includes a light source 32, a first lenses system 34, a mask pattern system 36, a pattern generator 38, and a second lenses system 40. The system operates on a subject 42, which is positioned on a subject stage 44. A resist layer or other energy-sensitive coating 46 is disposed on the subject 42.

The light source 32 and the lens systems 34, 40 may be of various types, depending on the requirements of a specific application. Selection of such components is well known by those of ordinary skill in the art. The mask pattern system 36 may be one or more typical computers with necessary processing capability, storage, and interface, as will be discussed below. The pattern generator 38 may be a digital/deformable mirror device, a liquid crystal display, a spatial light modulator, or other appropriate pixel-panel device, and may include appropriate drivers and memory.

In operation, the light source 32 provides a collimated beam of light 48 which is projected through the first lenses system 34 and onto the pattern generator 38. The pattern generator 38 is provided with mask information via suitable signal line(s) 37 from the mask pattern system 36. The mask information may represent an entire digital mask, or a portion of the digital mask, as required. The mask information is used by the pattern generator 38 to produce a digital mask pattern for a desired duration. Light emanating from the digital mask pattern of the pattern generator 38 then passes through the second lenses system 40 and onto the subject 42. In this manner, the digital mask pattern of the mask generator 38 is projected onto the resist coating 46 of the subject 42.

In some embodiments, any modifications and/or changes required in the digital mask can be made using the mask pattern system 36. As a result, the need for fabrication of a new physical mask, as would be required in conventional photolithography systems, is thus eliminated by the photolithography system 30 of the present disclosure. Also, changing digital masks for different exposure operations is done electronically, thereby eliminating the wear and tear associated with typical physical mask operations. As a result, substantial cost savings are realized in the manufacture of subjects which require the use of a patterning of a photo resist coated subject.

In addition, the present photolithography system 30 reduces a lead time associated with obtaining a particular mask, in addition to a reduced repair time in the event that changes to the mask become necessary after an initial design implementation. In other words, the lead time and repair time of producing a digital mask are almost negligible, as compared with conventional physical masks.

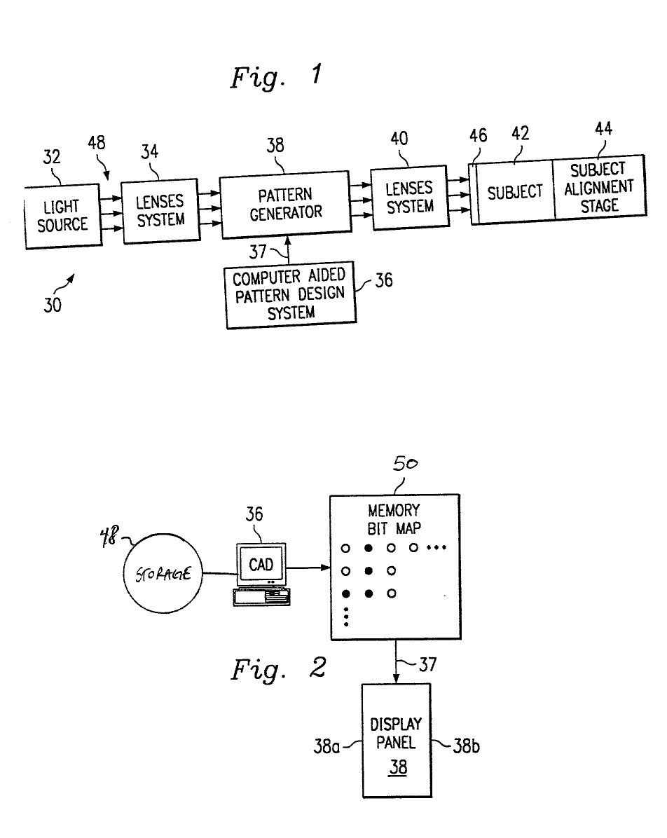

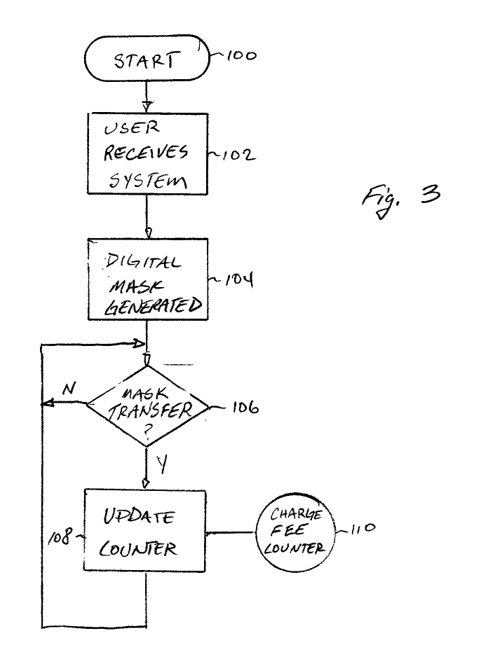

Referring now to FIG. 2, the mask pattern system 36 may include (either as a separate computer or a separate routine running in the same computer) a computer aided mask pattern design system for creating a desired digital mask. The digital mask may, for example, be stored in a memory 38 in the form of a bit map or the like. The bit map can include individual pixel data, which is subject to easy modification as may be required for the development of a particular integrated circuit design and/or mask pattern design.

With the use of the computer aided pattern design system 36, any bit can be easily changed or its location moved in a particular digital mask. Also, the digital mask can be changed or aligned as needed almost instantly with the use of an appropriate instruction from the computer aided pattern design system 36. In some embodiments, the computer aided pattern design system 36 may also be used for creating and simulating a circuit from initial design through any and all necessary design changes and/or modifications to the final digital masks. Once created, the digital masks may also be used for the creation of a conventional printed mask, such as can be used in a conventional photolithography system.

Once the digital mask has been constructed and saved in the memory 38, it can be provided to the display panel 38, as shown by memory bit map 40. In some embodiments, mask information representing only a portion of the entire mask pattern may to be delivered to the display panel 38. This allows the system 36 to accommodate data bottlenecks, such as available bandwidth in the signal lines 37 or the size and/or available memory in the display panel 38 (or associated drivers).

Business Method

Referring now to FIG. 3, a method 100 provides a new and unique way to monitor the activity of the photolithography system 30, and to measure payments for such activity. As a result, the method 100 may be used to compensate an owner or manufacturer of the system 30 for its use. Such compensation may be used in lieu of, or in addition to, the user paying a purchase price for the system. For example, the user may purchase the system hardware, and the method 100 may calculate software license payments for the software on a per-use basis.

The method 100 begins at step 102, when the user receives the photolithography system 30. The method 100 may be a software routine that runs on the mask pattern system 36 of FIG. 2. Part of the initial step of receiving the system 30 may include entering a userid into the software routine to activate the method 100 and to enable the system. The method 100 continues to run on the mask pattern system 36, and may be protected from improper access by various security measures well known in the art.

In the present example, the user does not purchase the system, but pays for the system based on the number of new digital masks used by the system. At step 104, one or more digital masks are provided. The digital masks may be created using the computer aided pattern design system 36 discussed above, or may be converted from an existing mask. For example, conventional digital data used to create a physical mask, or to run simulations on a desired integrated circuit, can be easily converted to the digital masks used in the system 30.

At step 106, the software routine detects when mask information is transferred to the pattern generator 38. In the present embodiment, the software routine specifically detects when mask information relating to a new or different digital mask is being transferred. In this way, a single digital mask can be repeatedly used, without incurring extra expense. In addition, for embodiments that do not transfer the entire digital mask at one time, but instead send portions to the pattern generator, the different portions are not perceived as new digital masks.

At step 108, each time a “new” digital mask is transferred to the pattern generator 38, a charge fee counter 110 is incremented. The method 100 continually checks for new digital masks, and updates the charge fee counter 110 accordingly. In some embodiments, a “new” digital mask is one that has never been transferred to the pattern generator 38. This may include modified masks (e.g., small changes were made to a previous mask), or brand new masks that relate to other layers or other circuit designs. In other embodiments, a “new” digital mask is simply a different mask than the immediate prior digital mask being used by the pattern generator 38.

At periodic intervals, the charge fee counter 110 is reviewed for payment. In one embodiment, each “new” digital mask is set to a predetermined reference value. One example of a predetermined reference value is a standard market cost of a conventional, physical mask. In another embodiment, different fees apply to brand new masks, modified masks, and different masks. Table 1, below, shows one such fee arrangement.

TABLE 1

| Type of New Mask | Cost (compared to reference values) |
|---|---|
| brand new | 50% |
| modified | 30% |
| different | 5% |

In furtherance of the example, if a conventional, physical mask costs one hundred thousand dollars, each brand new mask used by the system 30 will accrue a charge of fifty thousand dollars, each modified mask will accrue a charge of thirty thousand dollars, and each different mask will accrue a charge of five thousand dollars.

The charge fee counter 110 may also include an indicator that identifies a resolution of the digital mask. The above described fees may be modified for different resolution masks, which corresponds to the higher costs for conventional physical masks with high resolution. In this way, the reference value for each mask may be individually set by the corresponding cost of the alternative conventional physical mask that would provide the same resolution. Continuing the above-described example, a conventional physical mask used for 1 micron resolution may cost twenty thousand dollars, while a conventional physical mask for 0.18 micron resolution may cost one hundred thousand dollars.

Conclusion

The methods, routines, and applications discussed above provide many advantages. For one, the user does not have to purchase the photolithography system, which makes the user more likely to try the system.

Another advantage is that the costs associated with running the system are directly related to the cost of purchasing conventional, physical masks. Therefore, the operating cost of using the digital photolithography system tracks, or follows, traditional costs. So, if the mask pattern does not change, the fees are relatively low, as it would be for a conventional photolithography system.

Another advantage is that the system can be used for high resolution masks and low resolution masks, with the associated costs further tracking the cost of purchasing conventional, physical masks for the same purpose.

While the invention has been particularly shown and described with reference to the preferred embodiment thereof, it will be understood by those skilled in the art that various changes in form and detail may be made therein without departing form the spirit and scope of the invention.

What is claimed is:

1. A method for determining a usage fee for a digital photolithography system including a computer system and a digital pattern generator, the method comprising:
receiving a first digital mask into the computer system;
transferring at least a portion of the first digital mask to the digital pattern generator;
detecting that the first digital mask has been provided to the digital pattern generator;
updating a counter indicating said detection;
determining a first reference value for the first digital mask; and
determining the usage fee from the counter and the first reference value.

2. The method of claim 1 further comprising:
receiving a second digital mask into the computer system;
transferring at least a portion of the second digital mask to the digital pattern generator;
detecting that the second digital mask has been provided to the digital pattern generator; and
updating the counter indicating said detection of the second digital mask pattern.

3. The method of claim 2 further comprising:
determining a second reference value for the second digital mask; and
updating the usage fee from the counter and the second reference value.

4. The method of claim 3 wherein the first and second reference values are different, and correspond to corresponding conventional physical masks with similar resolutions to the first and second digital masks, respectively.

5. The method of claim 3 wherein the steps of determining and updating the usage fee include calculating a predetermined percentage of the respective reference values.

6. The method of claim 2 wherein the second digital mask is a brand new mask.

7. The method of claim 2 wherein the second digital mask is a modified version of the first digital mask.

8. The method of claim 2 wherein the second digital mask has never been used with the photolithography system.

9. The method of claim 2 wherein the photolithography system is used for multi-layer integrated circuit wafer fabrication, and the first and second digital masks are used to expose different layers of the integrated circuit onto a wafer substrate.

10. A computer program for use in a computing system connected to a digital photolithography system, the computer program comprising instructions for:
storing a first digital mask in the computing system;
transferring at least a portion of the first digital mask to a digital pattern generator of the digital photolithography system;
determining if the first digital mask being transferred is new;
updating a counter in response to determining the first digital mask is new;
determining a first reference value for the first new digital mask; and
determining a usage fee from the counter and the first reference value.

11. The computer program of claim 10 further comprising:
receiving a second digital mask into the computer system;
transferring at least a portion of the second digital mask to the digital pattern generator;
determining if the second digital mask being transferred is new; and
updating the counter in response to determining the second digital mask is new.

12. The computer program of claim 11 further comprising:
determining a second reference value for the second new digital mask; and
updating the usage fee responsive to the second reference value.

13. The computer program of claim 12 wherein the steps of determining and updating the usage fee include calculating a predetermined percentage of the respective reference values.

14. The computer program of claim 11 wherein the second new digital mask is a brand new mask.

15. The computer program of claim 11 wherein the second new digital mask is a modified version of the first new digital mask.

16. The computer program of claim 11 wherein the second new digital mask has never been used with the photolithography system.

17. The computer program of claim 11 wherein the photolithography system is used for multi-layer integrated circuit wafer fabrication, and the first and second new digital masks are used to expose different layers of the integrated circuit onto a wafer substrate.
